(19) United States
(12) Patent Application Publication
(10) Pub. No.: US 2015/0248772 A1
(43) Pub. Date: Sep. 3, 2015

(54) IMAGING SYSTEMS AND METHODS FOR MONITORING USER SURROUNDINGS

(71) Applicant: Semiconductor Components Industries, LLC, Phoenix, AZ (US)

(72) Inventors: Robert Gove, Los Gatos, CA (US); Brian Keelan, Boulder Creek, CA (US)

(21) Appl. No.: 14/193,548

(22) Filed: Feb. 28, 2014

(51) Int. Cl. G06T 7/20; G06T 7/00; H04N 5/247

(52) U.S. Cl. CPC G06T 7/2093; H04N 5/247; G06T 7/004; G06T 2207/30232

(57) ABSTRACT

An imaging system may include a first and second cameras having a wide-angle lenses and processing circuitry. The first and second cameras capture respective first and second sets of image data that may be combined by the processing circuitry to generate wide-angle images of substantially all of a user's surroundings. The processing circuitry may track objects located around the user using the wide-angle images. The processing circuitry may issue an alert when tracked objects are determined to be a hazardous or when tracked objects may have been lost. The first camera may be formed on a cellular telephone held by the user and may face in front of the user, whereas the second camera may be formed on a wearable article and may face behind the user. In this way, the imaging system may monitor the user's surroundings even when the user is distracted by other tasks.

### BACKGROUND

This relates generally to imaging systems, and more particularly, to imaging systems with multiple image sensors for generating and monitoring a wide angle view around the user of an imaging device.

Image sensors are commonly used in mobile electronic devices such as cellular telephones, cameras, and computers to capture images. The use of mobile electronic devices having image sensors has become common in public settings. For some mobile electronic device users, mobile electronic devices can pose a distraction that reduces the user's awareness of the surrounding environment. Distractions in public settings can cause accidents for the user such as causing the user to trip on or walk into obstacles, can generate a risk of theft of the mobile electronic device or other items belonging to the user, and can result in the user losing or leaving behind items due to a lack of awareness of their surroundings.

It would be desirable to provide mobile electronic devices with the ability to monitor a user's surroundings.

### BRIEF DESCRIPTION OF THE DRAWINGS

FIG. 1 is a diagram of an illustrative imaging system having an electronic device with an image sensor and processing circuitry that receives image data from peripheral imaging devices in accordance with an embodiment of the present invention.

FIG. 2 is a diagram of an illustrative image system having multiple image sensors for monitoring a user's surroundings in accordance with an embodiment of the present invention.

FIG. 3 is top-down diagram of an illustrative imaging system showing how first and second image sensors having wide-angle fields of view can be used to monitor substantially all sides of a user in accordance with an embodiment of the present invention.

FIG. 4 is a flow chart of illustrative steps that may be performed by processing circuitry in an electronic device to monitor a user's surroundings for potential hazards using image data captured by multiple wide-angle image sensors in accordance with an embodiment of the present invention.

FIG. 5 is a flow chart of illustrative steps that may be performed by processing circuitry in an electronic device to track objects of interest in a user's surroundings and to notify the user of the potential loss of the object of interest in accordance with an embodiment of the present invention.

FIG. 6 is a block diagram of a processor system employing the embodiments of FIGS. 1-5 in accordance with an embodiment of the present invention.

### DETAILED DESCRIPTION

Electronic devices such as digital cameras, computers, cellular telephones, and other electronic devices may include image sensors that gather incoming light to capture an image. The image sensors may include arrays of image pixels. The pixels in the image sensors may include photosensitive elements such as photodiodes that convert the incoming light into image signals. Image sensors may have any number of pixels (e.g., hundreds, thousands, millions or more). A typical image sensor may, for example, have hundreds of thousands or millions of pixels (e.g., megapixels). Image sensors may include control circuitry such as circuitry for operating the image pixels, readout circuitry for reading out image signals corresponding to the electric charge generated by the photosensitive elements, and, if desired, other processing circuitry such as analog processing circuitry and digital processing circuitry. An image sensor may be coupled to additional processing circuitry such as circuitry on a companion chip to the image sensor, circuitry in the device that is coupled to the image sensor by one or more cables or other conductive lines, or external processing circuitry.

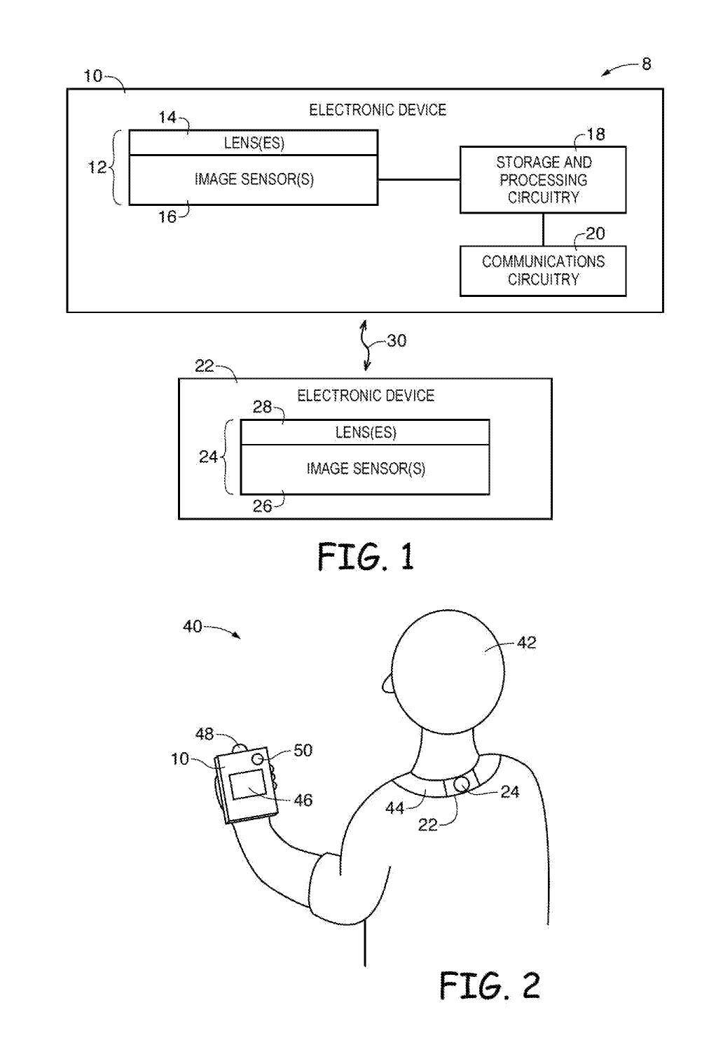

FIG. 1 is a diagram of an illustrative imaging system. As shown in FIG. 1, imaging system 8 may include an electronic device such as electronic device 10 that uses an image sensor to capture images. Electronic device 10 may be a portable electronic device such as a camera, a cellular telephone, a video camera, a tablet computer, a laptop computer, a webcam, a security camera, or other imaging device or imaging system that captures digital image data. Camera module 12 may be used to convert incoming light into electric charges and eventually into digital image data. Camera module 12 may include one or more lenses 14 and image sensor circuitry 16 (e.g., one or more corresponding image sensors 16). During image capture operations, light from a scene may be focused onto image sensor 16 by lens 14. If desired, lenses 14 may include one or more wide-angle lenses that focus light received over a 180 degree angular field of view or any other desired wide-angle field of view. Image sensor 16 may include circuitry for converting analog pixel data into corresponding digital image data to be provided to processing circuitry 18. If desired, camera module 12 may be provided with an array of lenses 14 and an array of corresponding image sensors 16.

Processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image sensor 16 may receive control signals from storage and processing circuitry 18 and may supply pixel data (e.g., image data that includes multiple pixel values) to storage and processing circuitry 18. Image data that has been captured by camera module 12 may be processed using storage and processing circuitry 18. Processed image data may, if desired, be provided to external equipment (e.g., a computer, external processing circuitry, a display, or other device) using wired and/or wireless communications paths coupled to processing circuitry 18.

If desired, device 10 may include communications circuitry such as communications circuitry 20 coupled to storage and processing circuitry 18. Communications circuitry 20 may support communicating between electronic device 10 and other electronic devices. For example, communications circuitry 20 may include radio-frequency circuitry (e.g., transceiver circuitry, baseband circuitry, front end circuitry, antenna circuitry, or any other desired radio-frequency circuitry) for conveying (e.g., transmitting and/or receiving) radio-frequency signals between storage and processing circuitry 18 and other electronic devices such as device 22 via communications link 30. Link 30 may be a wireless link or may be a wired link (e.g., a cable or other wired path) for conveying data between device 10 and device 22. Devices such as device 22 that are in communication with device 10 may sometimes be referred to herein as peripheral devices, peripheral imaging devices, peripheral camera devices, or peripheral imagers. Peripheral imaging device 22 may be a portable electronic device such as a camera, a cellular telephone, a video camera, a tablet computer, a laptop computer, a webcam, a security camera, or other imaging device or imaging system that captures digital image data.

As shown in FIG. 1, peripheral imaging device 22 may include a camera module 24 for capturing image data (sometimes referred to herein as a peripheral camera module). Camera module 24 may include one or more lenses 28 and image sensor circuitry 26 (e.g., one or more corresponding image sensors 26). During image capture operations, light from a scene may be focused onto image sensor 26 by lens 28. If desired, lenses 28 may include one or more wide-angle lenses that focus light received over a 180 degree angular field of view or any other desired wide angle field of view. Image sensor 26 may include circuitry for converting analog pixel data into corresponding digital image data. If desired, camera module 24 may be provided with an array of lenses 28 and an array of corresponding image sensors 26.

If desired, peripheral imaging device 22 may include storage and processing circuitry (not shown) for performing image processing operations on image data captured using camera module 24. If desired, peripheral imaging device 22 may include communications circuitry such as radio-frequency communications circuitry for supporting communications with electronic device 10. Peripheral imaging device 22 may transmit image data captured using camera module 24 to electronic device 10 over communications link 30. Communications circuitry 20 on electronic device 10 may receive image data from peripheral imaging device 22 and may pass the received image data to storage and processing circuitry 18.

Storage and processing circuitry 18 may perform image processing operations on image data captured by peripheral imaging electronic device 22. Storage and processing circuitry 18 may combine image data captured by camera module 12 with image data captured by camera module 24 when performing image processing operations.

If desired, camera module 12 may capture images from a first portion of a scene and camera module 24 may capture images from a second portion of the scene. Storage and processing circuitry 18 may combine image data received from peripheral device 22 with image data captured by image sensor 16 to perform image processing operations on both the first and second portions of the scene. For example, processing circuitry 18 may generate a wide-angle image of portions of a scene that are in front of and behind camera module 48 by combining image data captured by camera modules 24 and 48.

The example of FIG. 1 is merely illustrative. If desired, electronic device 10 may communicate with any desired number of peripheral imaging devices 22. For example, image data may be conveyed between device 10 and one peripheral device 22, two peripheral devices 22, three peripheral devices 22, or any other desired number of peripheral devices. Device 10 and/or peripheral device 22 may include input/output circuitry for interfacing with a user (e.g., so that a user can input commands to device 10 and so that the user can receive audio, visual, and/or haptic feedback from device 10). The input/output circuitry may include, for example, display circuitry, touch screen circuitry, button circuitry, keyboard circuitry, touch pad circuitry, audio circuitry, haptic feedback circuitry such as vibrator circuitry, indicator lights, alarm circuitry, inertial circuitry such as accelerometer circuitry that detects forces applied to the device, or any other desired input/output circuitry. If desired, device 10 may include multiple camera modules 12. For example, device 10 may include a front-facing camera module formed at a first side of device 10 and a rear-facing camera module formed at an opposing rear side of device 10.

Device 10 may be operated by a user. When operating electronic devices such as device 10 in certain environments such as in a public setting, device 10 may pose a distraction to the user and may reduce the user's awareness of their surroundings. Such distractions may pose a risk to the user of device 10 and may lead to accidents while operating device 10. For example, information displayed on device 10 may divert a user's attention from their surroundings and may cause accidents such as causing the user to trip or run into approaching objects or may lead to other hazards such as theft (e.g., theft of device 10 or other items belonging to the user of device 10). If desired, device 10 and/or peripheral device 22 may perform image processing operations on image data captured using camera module 12 and camera module 24 to monitor the user's surroundings even when the user is distracted with other tasks.

FIG. 2 is an illustrative diagram showing an example of how a user may be engaged with device 10 while in an environment such as a public setting. As shown in FIG. 2, user 42 may be located within environment 40 (e.g., a public setting such as a sidewalk, a park, public transportation, a street, etc.). User 42 may be moving or walking through environment 40 or may be stationary within environment 40. During operation of device 10, user 42 may hold device 10 in front of their body (e.g., so that the user may interact with one or more features of device 10). User 42 may interact with device 10, for example, by reading displayed information such as web pages, text messages, emails, or other information displayed on display 46, by playing video games on device 10, by taking photographs with device 10, by providing text input to device 10, by talking on device 10, or performing any other interaction with device 10. In the example of FIG. 2, user 42 is holding device 10 in front of their body. User 42 may be distracted by device 10 from observing events or obstacles in environment 40. For example, user 42 may not see obstacles or hazards directly in front of device 10, to the left of user 42, to the right of user 42, and behind user 42. It may therefore be desirable to provide an imaging system that continuously captures image data from all sides of user 42 and that monitors the image data for potential hazards and objects of interest.

Device 10 may include a front-facing camera module 50 formed on the same side of device 10 as display 46 and a rear-facing image sensor 48 formed on an opposing side of device 10 (e.g., rear-facing and front-facing camera modules such as camera modules 12 of FIG. 1). In the example of FIG. 2, rear-facing camera module 48 may capture image data from portions of environment 40 that are in front of user 42. Rear-facing camera module 48 may be generally unable to capture image data from the portions of environment 40 that are behind user 42. If desired, front-facing camera module 50 may be used to capture image data of portions of environment 40 that are behind user 42. However, in this scenario, user 42 may block front-facing camera module 50 from capturing image data for portions of the scene behind user 42.

If desired, user 42 may use a peripheral imaging device that communicates with device 10 such as peripheral imaging device 22 of FIG. 1 to capture image data from portions of environment 40 that are not covered by rear-facing camera module 48 of device 10. For example, user 42 may place peripheral imaging device 22 at a selected location so that peripheral camera module 24 captures image data from portions of environment 40 that are not covered by camera module 48 or camera module 50. In the example of FIG. 2, peripheral imaging device 22 is placed behind user 42 so that camera module 24 captures image data from portions of the environment behind user 42. Peripheral device 22 may wirelessly transmit captured image data to device 10. Device 10 may process image data received from peripheral device 22 for monitoring environment 40 for hazards and objects of interest located behind user 42. In this way, device 10 may monitor substantially all of the user's surroundings for potential hazards and objects of interest.

If desired, peripheral device 22 may be placed on a wearable article such as wearable article 44 that is worn by user 42. For example, wearable article 44 may be an article of clothing worn by user 42 such as a necklace, hat, bracelet, tie, belt, or any other desired article of clothing. As another example, wearable article 44 may be a pin or clip that can be affixed to a portion of user 42 (e.g., affixed to the user's body or clothing) and/or that can be affixed to objects in the vicinity of user 42 such as a chair, bench, wheelchair, scooter, car, vehicle, bicycle, etc. In another example, wearable article 44 may be an accessory such as a purse, backpack, satchel, briefcase, handbag, or any other accessory carried by user 42. If desired, wearable article 44 may include multiple peripheral imaging devices 22 and/or user 42 may wear multiple articles 44 so that any desired number of peripheral camera modules 24 are used to capture images of the user's surroundings.

In order to capture image data from as much of environment 40 as possible, rear-facing camera module 48 and/or peripheral camera module 24 may be provided with a wide-angle lens. The wide-angle lens formed on camera module 48 may focus light from substantially all of the portion of environment 40 located in front of user 42 and the wide-angle lens formed on peripheral camera module 24 may focus light from substantially all of the portion of environment 40 located behind user 42. In this way, device 10 and peripheral device 22 may capture image data from all sides of user 42 and may monitor all sides of user 42 for potential hazards. As an example, camera module 48 and peripheral camera module 24 may generate image data in response to light received from all 360 degrees around user 42 or from any desired range of angles around user 42 (e.g., camera modules 48 and 24 may cover 360 degrees around user 42, may cover 320 degrees around user 42, may cover 340 degrees around user 42, or may cover any other desired portion of environment 40 around user 42). In general, the coverage of environment 40 provided by camera module 48 and 24 may depend on the field of view of the wide-angle lenses formed on modules 48 and 24, on the positioning of modules 48 and 24 relative to user 42, and the orientation of modules 42 and 24.

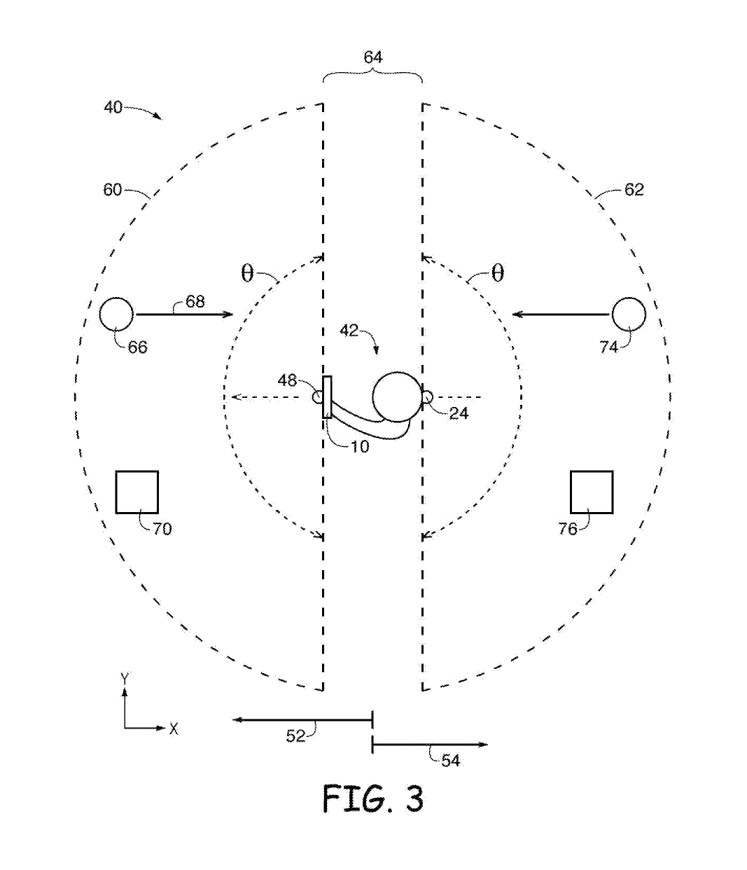

FIG. 3 is an illustrative top-down view of environment 40 showing how electronic device 10 and peripheral imaging device 22 may monitor the surroundings of user 42 for potential hazards. As shown in FIG. 3, user 42 may face direction front 52 whereas the back of user 42 may face opposing rear direction 54. Rear-facing camera module 48 may include a wide angle lens having an angular field of view θ in the lateral X-Y plane of FIG. 3. Wide-angle lenses may be defined herein as any lens having an angular field of view θ of greater than or equal to 120 degrees and may include, for example, quasi-fisheye lenses (e.g., lenses having a field of view in the horizontal plane of up to approximately 150 degrees) or fisheye lenses (e.g., lenses having a field of view in the horizontal plane of up to approximately 180 degrees) and may implement a so-called “extreme retrofocus” optical design. As examples, camera module 48 may include a lens that has a 120 degree field of view, a 130 degree field of view, a 140 degree field of view, a 150 degree field of view, a 170 degree field of view, or any other desired angular field of view that is greater than or equal to 120 degrees. In the example of FIG. 3, camera module 48 includes a wide-angle lens having an angular field of view θ of approximately 180 degrees so that camera module 48 can capture image data from all portions of environment 40 that are in front of user 42 (as shown by dashed lines 60).

Peripheral camera module 24 worn by user 42 may capture image data from portions of environment 40 that are not within field of view 60 of camera module 48. Peripheral camera module 24 may include a wide angle lens having an angular field of view θ in the X-Y plane. In the example of FIG. 3, peripheral camera module 24 includes a wide-angle lens having a 180 degree field of view so that peripheral camera module device 24 can capture image data from all parts of environment 40 that are behind user 42 (as shown by dashed lines 62). This example is merely illustrative. If desired, peripheral camera module 24 may include any desired wide-angled lens. For example, peripheral camera module 24 may include a wide-angled lens having a different angular field of view than camera module 48, may include a wide-angled lens having a 120 degree field of view, or any other desired field of view. While FIG. 3 shows the fields of view in the lateral X-Y plane, wide-angle lenses in camera module 48 and peripheral camera module 24 may have any desired vertical angular field of view (e.g., any desired angular field of view measured in a plane perpendicular to the X-Y plane of FIG. 3). If desired, wide-angle lenses in device 10 and/or peripheral imaging device 22 may each capture light from a hemisphere of environment 40 relative to user 42 or may capture light from a subset of a hemisphere of environment 40 (e.g., camera modules 48 and 24 may focus light received from 90 degrees above and below the horizon, from 60 degrees above and below the horizon, from 40 degrees above and below the horizon, from 80 degrees above and below the horizon, or any other desired subset of angles above and below the horizon).

In the example of FIG. 3, camera module 48 and peripheral camera module 24 capture image data from substantially every direction around user 42. However, due to lateral separation between camera module 48 and peripheral camera module 24, blind spots 64 (sometimes referred to herein as dead zones or dead spots) may form from which neither camera module 48 nor peripheral camera module 24 captures image data. If desired, image data for dead spots 64 may be captured by camera module 48 and/or peripheral camera module 24 as user 42 moves through environment 40 (e.g., when the user rotates device 10 or turns so that one of the camera modules covers blind spots 64). In general, camera module 48 and peripheral camera module 24 may have wide-angle lenses with any desired angular field of view that allows blind spots 64 to account for 40 degrees or less of the 360 degrees in the X-Y plane around user 42. In the example of FIG. 3, any desired wide-angle lenses may be formed on camera modules 48 and 24 having an angular field of view that is greater than or equal to 160 degrees (e.g., so that blind spots 64 do not cover excessive portions of environment 40). In other words, the wide-angle lenses of camera modules 48 and 24 may be selected to have a cumulative (total) angular field of view of 320 degrees or more (e.g., the sum of the angular fields of view of wide-angle lenses on camera modules 48 and 24 may be greater than or equal to 320 degrees).

The example of FIG. 3 is merely illustrative. If desired, portions of field of view 60 may overlap with portions of field of view 62 (e.g., depending on the positioning of peripheral device 22 and/or electronic device 10). In the example where lenses in device 10 and peripheral device 22 have 180 degree angular fields of view, wide angle lenses in device 10 and peripheral device 22 may cover as much of environment 40 as possible regardless of the orientation of device 10 and peripheral device 22.

Camera module 48 on device 10 may capture image data within field of view 60 from environment 40. Processing circuitry 18 on device 10 (as shown in FIG. 1) may process image data captured by camera module 48 to monitor one or more objects or points of interest within environment 40. For example, device 10 may monitor approaching objects such as 66 approaching user 42 (in a direction as shown by arrow 68). Object 66 may be, for example, a moving object such as a person (e.g., a person who may collide with user 42 or a person who attack or rob user 42), a car, a bicycle, an animal, a bird, or any other potentially hazardous moving object. In scenarios where user 42 is moving or walking through environment 40, object 66 may be a stationary object that poses a potential hazard to user 42 such as a pot hole, a low-hanging tree branch, a sign, an obstacle, a street curb, a tripping hazard, or any other potentially hazardous stationary object. Processing circuitry 18 may determine whether approaching object 66 is a hazard based on the image data captured by camera module 48. If processing circuitry 18 determines that object 66 is a hazard, device 10 may issue an alert to user 42 to warn user 42 of the hazard.

As another example, device 10 may monitor the location of objects of interest such as stationary object 70. Object 70 may, for example, be a valuable object such as a purse, keys, wallet, cell phone, tablet computer, laptop computer, a pet, a child, or other person or object that can be easily lost or stolen. Device 10 may continuously monitor the location of object 70 based on the captured image data to ensure that object 70 is always nearby user 42. If processing circuitry 18 determines that object 70 is no longer in sight, device 10 may issue an alert to user 42 to notify user 42 of the missing object.

Peripheral imaging device 22 may capture image data within field of view 62 from environment 40. Peripheral imaging device 22 may transmit the captured image data to device 10 for processing. In another suitable arrangement, peripheral imaging device 22 may perform processing operations on the image data using processing circuitry located on peripheral imaging device 22. Processing circuitry 18 on device 10 may process the captured image data to track potentially hazardous objects that are moving relative to user 42 that are located behind user 42 such as object 74 and/or to track objects of interest that are located behind user 42 such as object 76. Processing circuitry 18 may alert user 42 of potential hazards or when an object of interest is lost.

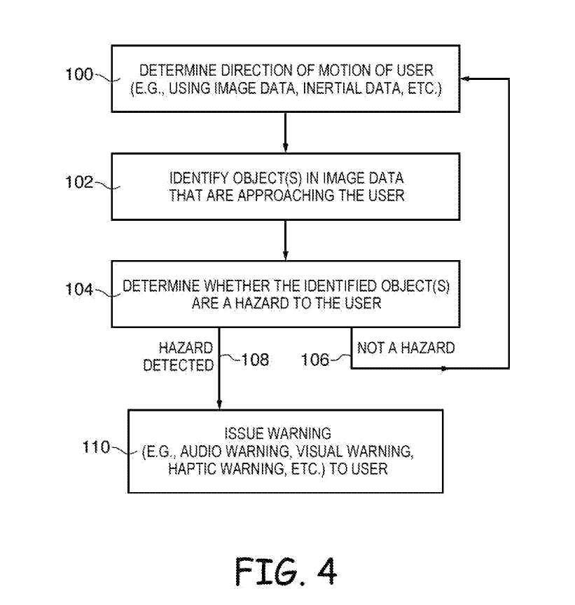

FIG. 4 shows a flow chart of illustrative steps that may be performed by processing circuitry on electronic device 10 and/or peripheral imaging device 22 for monitoring potentially hazardous objects in environment 40. The steps of FIG. 4 may, for example, be performed by processing circuitry 18 on device 10 to determine whether an object in environment 40 poses a potential hazard to user 42. The steps of FIG. 4 may, for example, be performed after capturing a set image data using camera module 48 and/or peripheral camera module 24 of FIG. 3 and may, if desired, be performed in real time while capturing additional image data using device 10 and peripheral imaging device 22. The image data captured using camera modules 48 and 24 may be combined (e.g., stitched together) to generate wide-angle image data of portions of environment 40 in front of and behind camera module 48 (sometimes referred to herein as near surround-view image data). If desired, processing circuitry 18 may process the wide-angle image data while monitoring environment 40 for hazards and objects of interest.

At step 100, processing circuitry 18 may determine a direction of motion of user 42 and/or camera module 48. For example, processing circuitry 18 may analyze frames of image data captured by camera module 48 and/or peripheral camera module 24 to determine a direction of motion of user 42 relative to environment 40. If desired, processing circuitry 18 may determine a direction of motion based on inertial data generated by inertial sensors in device 10 and/or device 22. As an example, processing circuitry 18 may determine that user 42 is walking in direction 52 as shown in FIG. 3.

At step 102, processing circuitry 18 may identify objects in the image data that are approaching user 42. For example, processing circuitry 18 may process successive frames of image data to identify objects that move closer to user 42 between frames. Objects identified by processing circuitry 18 as approaching user 42 may include stationary objects that user 42 is approaching in environment 40 or may include moving objects that are actively approaching user 42. As an example, processing circuitry 18 may identify object 66 in image data captured by camera module 48 that is approaching user 42 from the front and may identify object 74 in image data captured by peripheral camera module 24 that is approaching user 42 from behind, as shown in FIG. 3.

At step 104, processing circuitry 18 may determine whether the identified objects that are approaching user 42 are a potential hazard. For example, processing circuitry 18 may determine that the identified object is a potential hazard if user 42 is likely to collide with the identified object (e.g., based on the identified direction of motion of user 42), is likely trip over the identified object, etc. As another example, processing circuitry 18 may identify a speed of the moving object relative to user 42 and may determine that the object is a potential hazard if the speed of the object relative to user 42 is greater than a threshold speed. In another example, processing circuitry 18 may identify the size of the moving object and may determine that the object is a potential hazard if the size of the object is greater than a threshold size. In yet another example, processing circuitry 18 may identify a shape or appearance of the moving object and may determine that the moving object is a potential hazard if the shape or appearance of the moving object is sufficiently similar to the shape or appearance of known hazards. In general, processing circuitry 18 may perform any desired combination of these methods in determining whether the approaching object is a potential hazard. Determining the speed and size of the approaching object may allow processing circuitry 18 to determine whether the approaching object is a moving car (which could be a potential hazard) or some other less dangerous moving object, for example.

If processing circuitry 18 determines that the object is not a potential hazard, processing may loop back to step 100 as shown by path 106 to continue monitoring environment 40 for potential hazards. If processing circuitry 18 determines that the object is a potential hazard, processing may proceed to step 110 as shown by path 108.

At step 110, device 10 may issue a warning (e.g., an alert or alarm) to user 42 to inform user 42 of the hazard. For example, device 10 may issue an audio warning (e.g., a ringing alarm tone or other noise), a visual warning (e.g., device 10 may display a visual warning to user 42 using display 46), a haptic warning (e.g., by using vibrator circuitry to vibrate device 10), and/or any desired combination of visual, audio, and haptic warnings. If desired, device 10 may display image data using display 46 that shows the hazardous object to user 42. The image data displayed using display 46 may include, for example, the image data that caused processing circuitry 18 to determine that the moving object was hazardous, and/or live image data of the object. If desired, display 46 may highlight or otherwise point out the object while the image data is being displayed to user 42. Device 10 may identify a location of the hazardous and may identify evasive procedures that the user may take to avoid or mitigate the hazard. In this way, user 42 may become aware of the presence of the potentially hazardous object and the user may react or take other preventative measures to eliminate the potential hazard posed by the object.

As an example, processing circuitry 18 may determine that object 74 (as shown in FIG. 3) is about to collide with user 42 whereas object 66 is not going to collide with user 42. Processing circuitry 42 may thereby issue a warning to user 42 alerting user 42 that an object 74 is approaching from behind and is about to collide with user 42. User 42 may move out of the way or take other evasive action to avoid colliding with object 74. In this way, user 42 may avoid hazardous situations or accidents caused by objects that are approaching from directions that are out of view of the user.

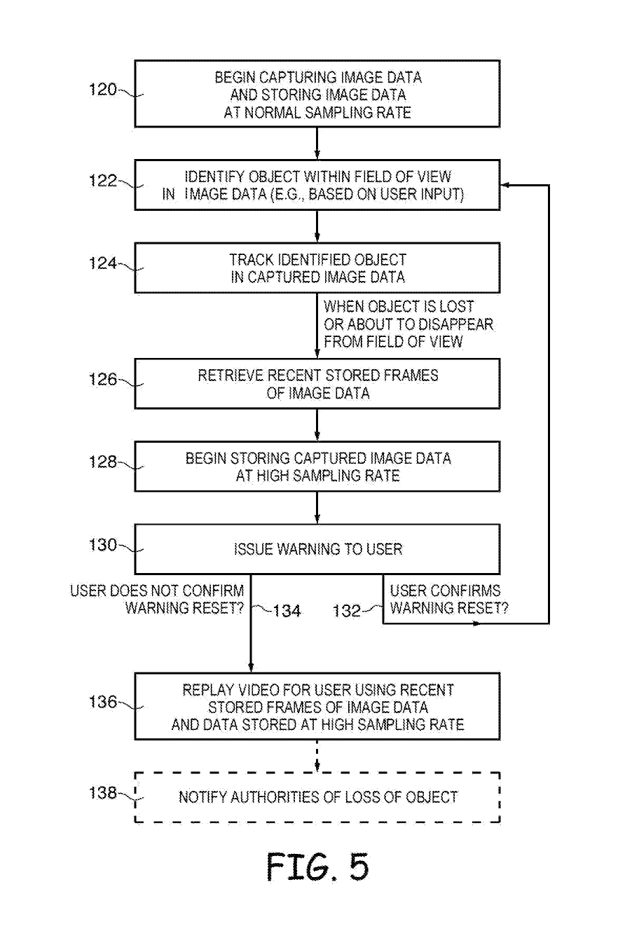

FIG. 5 shows a flow chart of illustrative steps that may be performed by processing circuitry on electronic device 10 and/or peripheral imaging device 22 for monitoring and tracking objects of interest in environment 40 (e.g., to prevent theft or loss of the object of interest). For example, the steps of FIG. 5 may allow device 10 to prevent an object of interest from being lost, stolen, or accidentally left behind.

At step 120, camera module 48 and peripheral camera module 24 may begin capturing frames of image data from environment 40. Peripheral device 22 may transmit captured image data to device 10 for processing. Device 10 may temporarily store (e.g., sample) image data captured by camera module 48 and peripheral camera module 24 at storage and processing circuitry 18 at a selected sampling rate. For example, processing circuitry 18 may sample recent frames of image data captured by camera modules 48 and 24 and may overwrite the stored frames on a continuous basis (e.g., so that only recent frames of image data are stored on processing circuitry 18 at any given time).

At step 122, processing circuitry 18 may identify an object within the field of view of camera module 48 and/or peripheral camera module 24 as an object of interest. As an example, user 42 of device 10 may select an object in the image data to identify as an object of interest (e.g., by providing a user input to device 10). If desired, user 42 may point camera module 48 and/or peripheral camera module 24 at the object of interest to ensure that the object of interest is within the field of view of camera module 48 and/or peripheral camera module 24, and may identify the object of interest as such by providing a user input to device 10. In another suitable arrangement, processing circuitry 18 may autonomously identify an object of interest in the image data.

At step 124, processing circuitry 18 may track the identified object of interest through the fields of view of camera modules 48 and peripheral camera module 24 (e.g., using an interest point tracking algorithm or any other desired tracking algorithm). If desired, processing circuitry 18 may track the position of the object of interest, may track the relative position of the object of interest relative to the background of environment 40, may determine whether the object of interest is moving, and/or may monitor the angular subtense of the object of interest (e.g., the apparent size of the object of interest). If the object of interest becomes obscured from view of camera module 48 and camera module 22, leaves the field of view of camera module 48 and camera module 24, exhibits excessive motion relative to the background of environment 40, and/or excessively diminishes in size (e.g., indicating that the object is becoming far away from user 42), processing may proceed to step 126.

At step 126, processing circuitry 18 may retrieve recent frames of stored image data so that the recent frames are not overwritten by subsequently captured image data. The recent frames of image data may show the object of interest prior to when the object was lost from the field of view of camera modules 48 and 24. The recent frames of image data may, for example, be useful in determining how the object of interest was lost or stolen and may be useful in determining where the object of interest has gone.

At step 128, processing circuitry 18 may begin storing subsequent frames of image data captured by camera modules 48 and 24 at a higher sampling rate (e.g., a greater sampling rate than the selected sampling rate with which the frames of image data are normally sampled). In this way, more image data may be available for inspection immediately after the object of interest was lost from the field of view of camera modules 48 and 24 (e.g., the subsequently captured frames of image data may be useful in determining how the object of interest was lost or stolen or in determining where the object of interest has gone).

At step 130, device 10 may issue a warning (e.g., an alert or alarm) to user 42 to inform user 42 that the object of interest has been lost from the field of view. For example, device 10 may issue an audio warning (e.g., a ringing alarm tone or other noise), a visual warning (e.g., may display a visual warning to user 42 using display 46), a haptic (tactile) warning (e.g., by using vibrator circuitry to vibrate device 10), and/or any desired combination of visual, audio, and haptic warnings to alert the user that the object of interest has been lost from view. After receiving the warning, the user may assess environment 40 to confirm whether the object of interest has been lost or stolen.

If desired, user 42 may reset the warning (e.g., using a user input to device 10) and processing may loop back to step 122 as shown by path 132 to resume object tracking operations. In one example, the object of interest may have moved into a blind spot 64 (as shown in FIG. 3). Upon receiving the warning, user 42 may visually assess environment 40 and may determine that the object of interest has moved to blind spot 64. User 42 may reposition camera module 48 and/or peripheral camera module 24 so that the object of interest is no longer in a blind spot (e.g., so that the object of interest is located within one of fields of view 60 and 62). If user 42 confirms that the object of interest has been lost or stolen, processing may proceed to step 136 as shown by path 134. If desired, user 42 may provide a user input to device 10 to confirm that the user does not wish to reset the warning and/or device 10 may autonomously proceed to step 136 if no user input is received after a predetermined length of time.

At step 136, device 10 may replay the image data for user 42 (e.g., using display 46 as shown in FIG. 2) using the recently stored image frames (e.g., the frames retrieved while processing step 126) and the image data stored at the high sampling rate. In this way, user 42 may examine the image data to identify how the object of interest was lost or stolen and may potentially identify where the object of interest has gone. At optional step 138, device 10 may notify the authorities of the loss of the object of interest. For example, if the object of interest was stolen, device 10 may initiate a telephone call with the police or may otherwise notify the policy that a theft has occurred.

As an example, processing circuitry 18 may identify object 70 as shown in FIG. 3 as an object of interest and may track the position of object 70 throughout fields of view 60 and 62. Device 10 may, for example, issue a warning to user 42 if object 70 moves outside of fields of view 60 and 62, if object 70 becomes excessively small (e.g., indicating that object 70 has become excessively far away from user 22), if object 70 moves excessively fast with respect to the background of environment 40, or if an obstruction blocks object 70 from being in view of camera modules 48 and 24. If desired, processing circuitry 18 may determine whether object 70 has entered blind-spot 64 (e.g., using information about the fields of view of camera modules 48 and 24 and/or the geometry and layout of environment 40) and may omit steps 126-138 of FIG. 5 if processing circuitry 18 has determined that object 70 has merely entered blind-spot 64 or if processing circuitry 18 determines that object 70 is merely passing between fields of view 60 and 62. In another suitable arrangement, device 10 may notify user 42 when object 70 has entered blind-spot 64 or if an object has obstructed object 70 and may instruct user 42 to re-position camera module 48 and/or camera module 24 so that object 70 is once again within at least one of fields of view 60 and 62.

The example of FIGS. 1-5 are merely illustrative. If desired, any camera module on device 10 may be used (e.g., front facing camera module 50, rear facing camera module 48, or other camera modules located on device 10) to monitor the surroundings of user 42. If desired, one or more peripheral devices 22 may be formed remote from user 42. For example, peripheral device 22 may be formed as a part of a security camera or any other desired imaging device that monitors user 42 within environment 40 and that communicates wirelessly with mobile electronic device 10. If desired, camera modules 48 and/or 24 may include hybrid multi-array technology and tilted barrel lenses to cover any desired wide-angle field of view. In another suitable arrangement, camera module 48 and peripheral camera module 22 may wirelessly transmit captured image data to remote processing circuitry for monitoring potential hazards and objects of interest in environment 40 (e.g., remote processing circuitry formed on a separate electronic device such as a security computer system or personal computer system that is located remote to user 42 and/or environment 40).

If desired, user 42 may monitor environment 40 using any desired number of peripheral imaging devices 22. For example, user 42 may operate two peripheral imaging devices 22 in conjunction with electronic device 10 and each peripheral imaging device 22 may monitor objects of interest and potential hazards within a portion of environment 40. In the example where two peripheral imaging devices 22 are used, each peripheral imaging device 22 may have a wide-angle lens with a 120 degree field of view, for example (e.g., so that the three camera modules may have a total angular field of view of 360 degrees to cover all of the user's surroundings). In general, the wide-angle lenses of camera module 48 and each peripheral camera module 24 may cumulatively cover at least 320 degrees around user 42 in order to provide suitable monitoring capabilities of the surroundings of user 42 (e.g., camera module 48 and peripheral camera module 24 may provide a near surround-view of 320 degrees or more). In this way, user 42 may be provided with situational awareness of environment 40 even when occupied with distractions such as content displayed on device 10, so as to mitigate possible hazards to user 42 posed by objects within environment 40 and to prevent theft or loss of valuables or other objects of interest.

If desired, camera modules 48 and 24 may collect depth information from environment 40 (e.g., using phase detection pixels, time-of-flight pixels, or separate sensors such as ultrasonic detectors). Depth information collected by modules 48 and 24 may, for example, include information about the distance between objects in environment 40 and camera modules 48 and 24. In this scenario, the combined field of view (near-surround view) of camera modules 48 and 24 may be processed by processing circuitry 18 and/or displayed on device 10 (e.g., using display 46) or on remote display devices as a “birds-eye” that shows user 42 from above (e.g., a top down view of user 42 and the user's immediate surroundings). Such a birds-eye view may be useful for monitoring the user's surroundings for hazards and objects of interest and may, when displayed on device 10, provide the user with a broad view of portions of environment 40 that would otherwise be unseen by the user.

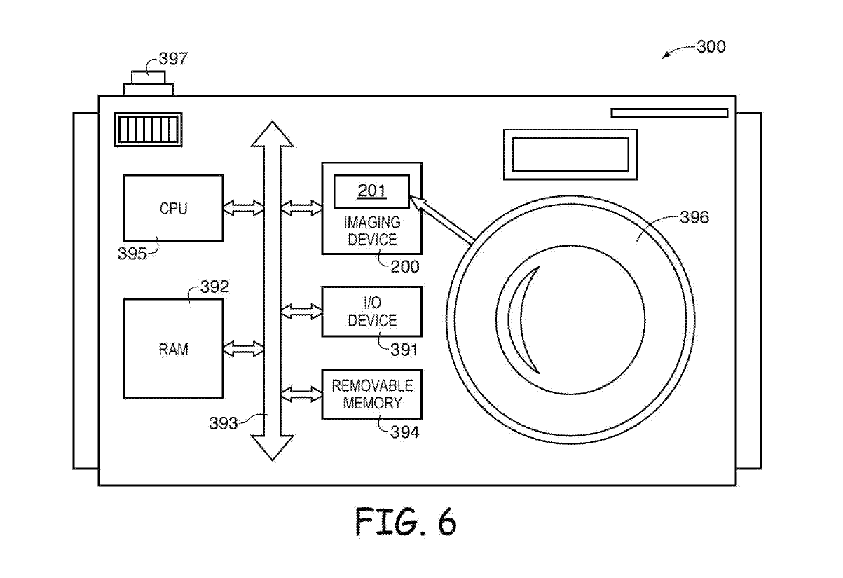

FIG. 6 shows in simplified form a typical processor system 300, such as a digital camera, which includes an imaging device 200 (e.g., an imaging device 200 such as device 10 and/or device 22 of FIGS. 1-5 and the techniques for monitoring an environment for potential hazards and tracking objects of interest). The processor system 300 is exemplary of a system having digital circuits that could include imaging device 200. Without being limiting, such a system could include a computer system, still or video camera system, scanner, machine vision, vehicle navigation, video phone, surveillance system, auto focus system, star tracker system, motion detection system, image stabilization system, and other systems employing an imaging device.

The processor system 300 generally includes a lens 396 for focusing an image on pixel array 201 of device 200 when a shutter release button 397 is pressed, central processing unit (CPU) 395, such as a microprocessor which controls camera and one or more image flow functions, which communicates with one or more input/output (I/O) devices 391 over a bus 393. Imaging device 200 also communicates with the CPU 395 over bus 393. The system 300 also includes random access memory (RAM) 392 and can include removable memory 394, such as flash memory, which also communicates with CPU 395 over the bus 393. Imaging device 200 may be combined with the CPU, with or without memory storage on a single integrated circuit or on a different chip. Although bus 393 is illustrated as a single bus, it may be one or more busses or bridges or other communication paths used to interconnect the system components.

Various embodiments have been described illustrating imaging systems and methods of operating image systems having multiple camera modules with wide-angle lenses for capturing image data from substantially all of a user's surroundings to monitor the surroundings for potential hazards and objects of interest.

The imaging system may include a mobile electronic imaging device such as a cellular telephone, laptop computer, tablet computer, or other portable electronic device. The imaging system may include one or more peripheral imaging devices that are remote to (e.g., formed separately from) the mobile electronic imaging device. The mobile electronic imaging device may include a first camera module having a first wide-angle lens and the peripheral imaging device may include a second camera module having a second wide-angle lens. The first and second wide-angle lenses may have angular fields of view of between 120 and 180 degrees, for example (e.g., the first and second wide-angle lenses may have a total angular field of view or near surround-view of between 320 and 360 degrees).

The first camera module may capture a first set of image data in response to light received from a first portion of a scene and the second camera module may capture a second set of image data in response to light received from a second portion of the scene (e.g., the first and second portions of the scene may overlap or may be different depending on the orientation of the first and second camera modules). As an example, the first portion of the scene may be located in front of the first camera module whereas the second portion of the scene may be located behind the first camera module (e.g., behind a user of the imaging system). The second camera module may wirelessly transmit the captured second set of image data to processing circuitry on the mobile electronic device. The processing circuitry may combine the first and second sets of captured image data to generate wide-angle image data (e.g., near-surround view image data of the user's surroundings).

The processing circuitry may track objects in the scene using the captured first and second sets of image data (e.g., using the wide-angle image data). If desired the processing circuitry may identify a direction of motion of the first camera module and may identify and track objects in the scene that are approaching the first and/or second camera modules using the first and second sets of captured image data. The processing circuitry may determine whether the approaching object is hazardous based on the direction of motion of the first camera module and the first and second sets of image data and may issue a warning (e.g., a visual, audio, and/or haptic warning) to a user in response to determining that the approaching object is hazardous.

If desired, the processing circuitry may determine whether the tracked object leaves the total field of view of the first and second wide-angle lenses (e.g., whether the tracked object is no longer within the field of view of the first and second wide-angle lenses) and may issue an alert to a user in response to determining that the tracked object has left the fields of view of the first and second wide-angle lenses. If desired, the processing circuitry may storing the first and second sets of image data at a first sampling rate and may increase the sampling rate in response to determining that the tracked object has left the fields of view of the first and second wide-angle lenses.

The foregoing is merely illustrative of the principles of this invention and various modifications can be made by those skilled in the art without departing from the scope and spirit of the invention. The foregoing embodiments may be implemented individually or in any combination.

What is claimed is:

1. A method for operating an imaging system that includes processing circuitry, a first camera module having a first wide-angle lens, and a second camera module having a second wide-angle lens, the method comprising:
with the first camera module, capturing a first set of image data in response to light received from a first portion of a scene and conveying the captured first set of image data to the processing circuitry;
with the second camera module, capturing a second set of image data in response to light received from a second portion of the scene and wirelessly transmitting the captured second set of image data to the processing circuitry; and
with the processing circuitry, combining the first and second sets of captured image data to generate wide-angle image data.

2. The method defined in claim 1, wherein the first portion of the scene is located in front of the first camera module and wherein the second portion of the scene is located behind the first camera module.

3. The method defined in claim 1, further comprising:
with the processing circuitry, tracking an object in the scene using the captured first and second sets of image data.

4. The method defined in claim 3, further comprising:
with the processing circuitry, identifying a direction of motion of the first camera module.

5. The method defined in claim 4, further comprising:
with the processing circuitry, identifying an approaching object in the scene using the first and second sets of captured image data; and
with the processing circuitry, tracking the identified approaching object in the scene.

6. The method defined in claim 5, wherein tracking the identified approaching object in the scene comprises:
determining whether the approaching object is hazardous based on the direction of motion of the first camera module and the first and second sets of image data; and
in response to determining that the approaching object is hazardous, issuing a warning to a user of the imaging system.

7. The method defined in claim 6, wherein the imaging system further comprises a display and wherein issuing the warning to the user of the imaging system comprises:
displaying a visual alert to the user of the imaging system that identifies the approaching object.

8. The method defined in claim 3, wherein the first and second wide-angle lenses have a total angular field of view that is greater than or equal to 320 degrees, the method further comprising:
with the processing circuitry, determining whether the tracked object leaves the total angular field of view of the first and second wide-angle lenses; and
in response to determining that the tracked object has left the total angular field of view of the first and second wide-angle lenses, issuing an alert to a user of the imaging system.

9. The method defined in claim 8, further comprising:
with the processing circuitry, storing the first and second sets of image data at a first sampling rate; and
in response to determining that the tracked object has left the total angular field of view of the first and second wide-angle lenses, storing additional image at data on the processing circuitry at a second sampling that is greater than the first sampling rate.

10. The method defined in claim 8, wherein the imaging system further comprises a display, the method further comprising:
with the display, displaying the wide-angle image data in response to determining that the tracked object has left the total angular field of view of the first and second wide-angle lenses.

11. An imaging system, comprising:
a first imaging device having a first wide-angle lens, wherein the first imaging device is configured to generate a first set of image data in response to light received through the first wide-angle lens from a first portion of a scene;
a second imaging device having a second wide-angle lens, wherein the second imaging device is configured to generate a second set of image data in response to light received through the second wide-angle lens from a second portion of the scene; and
processing circuitry configured to track an object in the scene based on the first and second sets of image data.

12. The imaging system defined in claim 11, wherein the first imaging device comprises the processing circuitry and wherein the second imaging device is separate from the first imaging device.

13. The imaging system defined in claim 12, wherein the first imaging device comprises wireless communications circuitry configured to wirelessly receive the second set of image data from the second imaging device.

14. The imaging system defined in claim 13, wherein the first wide-angle lens has a first angular field of view, wherein the second wide-angle lens has a second angular field of view, and wherein the first and second angular fields of view are between 120 degrees and 180 degrees.

15. The imaging system defined in claim 14, wherein the processing circuitry is configured to determine whether the tracked object is located within the first and second angular fields of view.

16. The imaging system defined in claim 15, wherein the processing circuitry is further configured to generate a warning for a user of the imaging system in response to determining that the tracked object is not located within the first and second angular fields of view.

17. The imaging system defined in claim 14, wherein the first imaging device comprises a cellular telephone.

18. The imaging system defined in claim 17, wherein the second imaging device comprises a wearable article that is configured to be worn by a user.

19. A system, comprising:
a central processing unit;
memory;
input-output circuitry; and
an imaging device, wherein the imaging device comprises:
an array of image sensor pixels;
a wide-angle lens that focuses an image on the array, wherein the array is configured to generate a first set of image data in response to the focused image;
wireless communications circuitry configured to wirelessly receive a second set of image data from a remote peripheral imaging device; and
storage and processing circuitry, wherein the storage and processing circuitry is configured to combine the first and second sets of captured image data to generate wide-angle image data and wherein the storage and processing circuitry is configured to track an object in the wide-angle image data.

20. The system defined in claim 19, wherein the remote peripheral imaging device has an additional wide-angle lens, wherein the wide-angle lens and the additional wide-angle lens have a total angular field of view that is greater than or equal to 320 degrees.
